(19) United States
(12) Patent Application Publication
(10) Pub. No.: US 2005/0028103 A1
(43) Pub. Date: Feb. 3, 2005

(54) Editing device

(76) Inventor: Takayuki Yamamoto, Kanagawa (JP)

Correspondence Address: WILLIAM S. FROMMER, Esq.;c/o FROMMER LAWRENCE & HAUG LLP, 745 Fifth Avenue, New York, NY, 10151, US

(21) Appl. No.: 10/901,856

(22) Filed: Jul. 28, 2004

(30) Foreign Application Priority Data
Jul. 30, 2003 (JP) P2003-283198

(51) Int. Cl. G09G 5/00; G11B 27/00

(52) U.S. Cl. 715/723; 386/4; 386/52; 715/725

(57) ABSTRACT

An editing device is capable of significantly simplifying editing work of sequence data. When a user operates an operating device to join existing sequence data SD1 being stored in the hard disk drive 4 and material data MD3, the CPU 2 creates new sequence data SD2 by joining the material data MD3 to reference data RD1 to access the existing sequence data SD1.

### BACKGROUD OF THE INVENTION

1. Field if the Invention

This invention relates to an editing device and, more particularly, is suitably applied to a case of creating sequence data by joining plural kinds of material data.

2. Description of the Related Art

Conventional editing devices are designed to be able to join plural kinds of material data captured by cameras or the like according to user operation, thus creating a series of video data (hereinafter, referred to as sequence data) as shown in FIG. 1 (for example, refer to Japanese Patent Laid Open No. 2002-247504 (second section)).

There is a case where a user wants to use existing sequence data created in the past to create new sequence data.

In this case, as shown in FIG. 2, such a conventional editing devices copies existing sequence data SD11 being stored in a hard disk drive 4 to create copy data SD11′ and then joins the copy data SD11′ and another material data MD11 to create new sequence data SD12 which is then stored in a prescribed area of the hard disk drive 4.

At this time, the CPU 2 also creates storage position information INF12 indicating where the sequence data SD12 exists and stores this information INF12 in a memory 3. Similarly, storage position information INF11 being stored in the memory 3 indicates where the sequence data SD11 exists.

When the user operate a prescribed operating device (not shown) to newly apply effects to the sequence data SD11, for example, the CPU 2 accesses the sequence data SD11 in the hard disk drive 4 based on the storage position information INF11 being stored in the memory 3, and puts the data SD11 in the memory 3 to apply the effects.

In addition, the user may desire to apply the same effects to the sequence data SD11 (copy data SD11′) included in the sequence data D12. To do this, the user has to newly apply the effects to the copy data SD11′ as well. This makes the editing work complicated.

### SUMMARY OF THE INVENTION

In view of foregoing, an object of this invention is to provide an editing device capable of significantly simplifying editing work of sequence data.

The foregoing objects and other objects of the invention has been achieved by the provision of an editing device with a sequence data creation means for creating sequence data by joining plural kinds of material data and a storage means for storing the sequence data created by the sequence data creation means. The sequence data creation means creates new sequence data based on existing sequence data and another material data by joining reference data to access the existing sequence data being stored in the storage means and the material data.

As a result, with this editing device, editing process performed on existing sequence data can be automatically performed on new sequence data including the existing sequence data as well, thus making it possible to realize an editing device capable of significantly simplifying editing work of sequence data.

Further, this invention provides a sequence data creation method with a sequence data creation step of crating sequence data by joining plural kinds of material data and a storing step of storing the sequence data created in the sequence data creation step, in a prescribed storage means. New sequence data based on existing sequence data and another material data is created by joining reference data to access the existing sequence data being stored in the storage means and the material data.

As a result, with this sequence data creation method, editing process performed on existing sequence data can be automatically performed on new sequence data including the existing sequence data as well, thus making it possible to realize a sequence data creation method capable of significantly simplifying editing work of sequence data.

Still further, this invention provides a sequence creation program causing a computer to execute a sequence data creation step of creating sequence data by joining plural kinds of material data and a storing step of storing sequence data created in the sequence data creation step, in a prescribed storage means. In the sequence data creation step, new sequence data based on existing sequence data and another material data is created by joining reference data to access the existing sequence data being stored in the storage means and the material data.

As a result, with this sequence data creation program, editing process performed on existing sequence data can be automatically performed on new sequence data including the existing sequence data as well, thus making it possible to realize a sequence data creation program capable of significantly simplifying editing work of sequence data.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic diagram showing a structure of sequence data;

FIG. 2 is a schematic diagram showing conventional editing process of sequence data;

FIG. 3 is a block diagram showing the construction of an editing device according to this embodiment;

FIG. 4 is a flowchart showing an editing procedure;

FIG. 5 is a schematic diagram showing temporal information; and

FIG. 6 is a schematic diagram showing a group of hierarchized sequence data; and

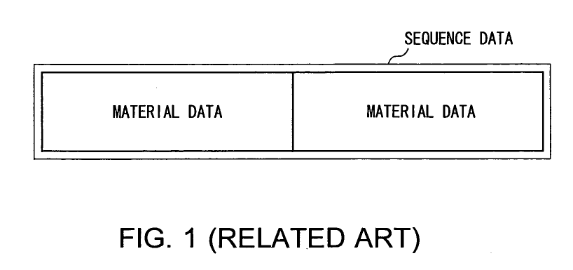

### DETAILED DESCRIPTION OF THE EMBODIMENT

Preferred embodiments of this invention will be described with reference to the accompanying drawings:

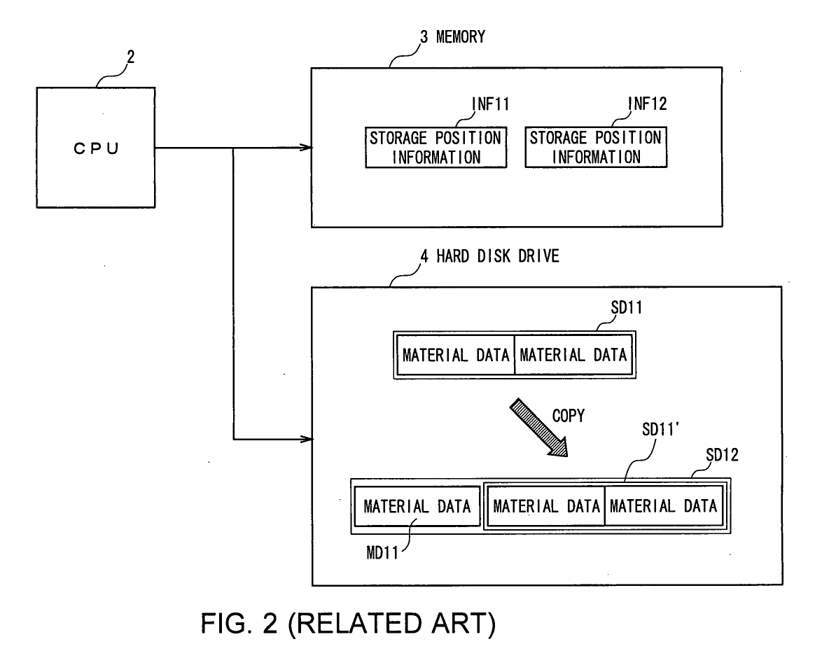

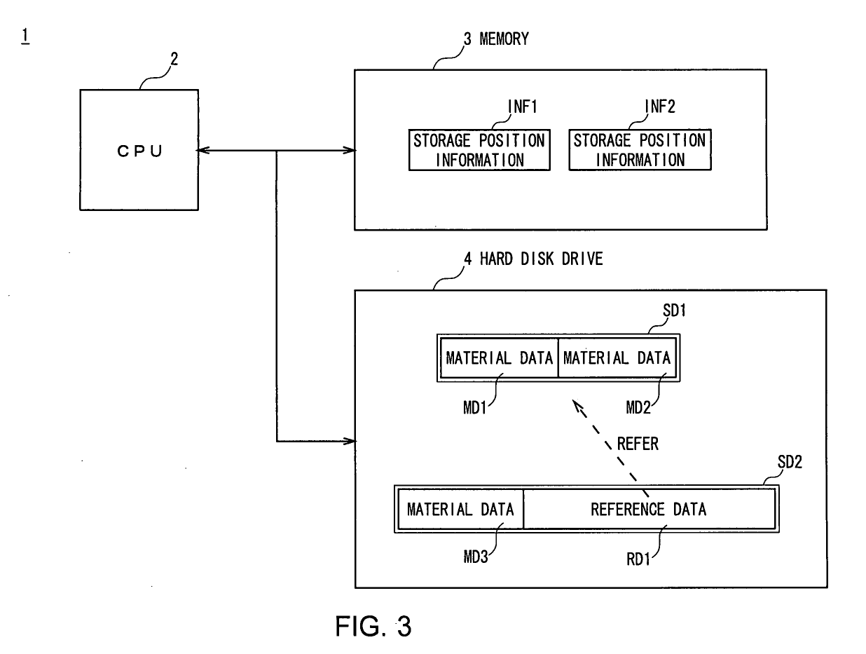

Referring to FIG. 3 where the same reference numerals are applied to parts corresponding to those of FIG. 2, reference numeral 1 shows an editing device in which a memory 3 and a hard disk drive 4 are connected to a central processing unit (CPU) 2.

The hard disk drive 4 has a material data storage area (not shown) which previously stores plural kinds of material data captured by a camera or the like.

In addition, the hard disk drive 4 previously stores a sequence data creation program (not shown) to create sequence data.

When a user operates an operating device (not shown) to join material data MD1 and MD2 being stored in the material data storage area, the CPU 2 executes a sequence data creation process with the sequence data creation program to create sequence data SD1 comprising the material data MD1 and MD2 and stores the data SD1 in a prescribed storage area of the hard disk drive 4.

At this time, the CPU 2 also creates storage position information INF1 indicating where the sequence data SD1 exists and stores this information in the memory 3.

Further, when the user operates the operating device to join the existing sequence data SD1 being stored in the hard disk drive 4 and material data MD3 being stored in the material data storage area, the CPU 2 creates new sequence data SD2 by joining the material data MD3 taken out from the material data storage area to reference data RD1 comprising information (storage position information of the sequence data SD1) to access the existing sequence data SD1.

Furthermore, when the user operates the operating device to playback the newly created sequence data SD2, the CPU 2 first sequentially playbacks video based on the material data MD3 on a prescribed display unit (not shown). Then after completing the playback of the material data MD3, the CPU 2 sequentially playbacks video based on the sequence data SD1 by accessing the data SD1 based on the reference data RD1 joined to the material data MD3.

In this way, this editing device 1 is able to use existing sequence data SD1 to create new sequence data SD2.

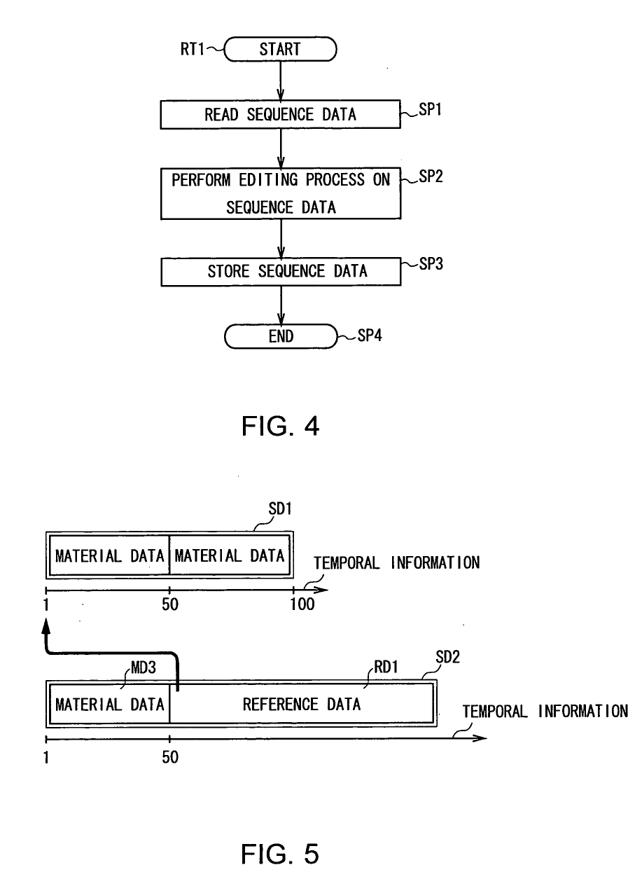

When the user operates the operating device to apply effects to the sequence data SD1, the CPU 2 execute an editing process with an editing procedure RT1 shown in FIG. 4.

In step SP1, the CPU 3 accesses the sequence data SD1 in the hard disk drive 4 based on the storage position information INF1 being stored in the memory 3, puts the data SD1 in the memory 3, and then moves on to step SP2.

In step SP2, the CPU 2 executes the editing process to apply the effects to the sequence data SD1 put in the memory 3. After completing this editing process, the CPU 2 moves on to step SP3.

In step SP3, the CPU 2 re-stores the sequence data SD1 subjected to the effects, in the hard disk drive 4, and moves on to step SP4 where this editing procedure RT1 is completed.

When the user operates the operating device to playback the sequence data SD2 after this editing process is completed, the CPU 2 first sequentially playbacks video based on the material data MD3 of the sequence data SD2 on the display unit.

After completing the playback of the video based on the material data MD 3, the CPU 2 sequentially playbacks video based on the sequence data SD1 by accessing the sequence data SD1 subjected to the effects, based on the reference data RD1 joined to the material data MD3. That is, the editing process (effects) applied to the sequence data SD1 can be reflected in the video based on the sequence data SD2.

According to the above configuration, when the user operates the operating device to join the existing sequence data SD1 being stored in the hard disk drive 4 and the material data MD3, the CPU 2 creates the new sequence data SD2 by joining the material data MD 3 to reference data RD1 to access the existing sequence data SD1.

To playback the reference data RD1 of the sequence data SD2 created by using the existing sequence data SD1, the CPU 2 playbacks video based on the existing sequence data SD1 by accessing the data SD1 based on the reference data RD1. That is, even an editing process is newly applied to only the sequence data SD1, this editing process can be reflected in video obtained by reproducing the sequence data SD2.

According to the above configuration, the editing process performed on the existing sequence data SD1 is automatically reflected in the sequence data SD2 created by using the existing sequence data SD1, so that the user does not have to perform the same editing process on the sequence data SD2 differently. This significantly simplifies the editing work.

By the way, at the time of playing back the sequence data SD2, the editing device 1 accesses and sequentially playbacks the sequence data SD1 from the beginning after completing the playback of the material data MD3. In this case, as shown in FIG. 5, the temporal information added to the sequence data SD2 does not match the temporal information added to the sequence data SD1, so that the readout position from the material data storage area of the hard disk drive 4 may be different from user desired position. Therefore, in this editing device 1, matching temporal information based on which the sequence data SD1 is reproduced via the sequence data SD2 is previously stored in, for example, the reference data RD1. And at a time of the reproduction of the sequence data SD2, the sequence data SD1 is reproduced based on the stored temporal information.

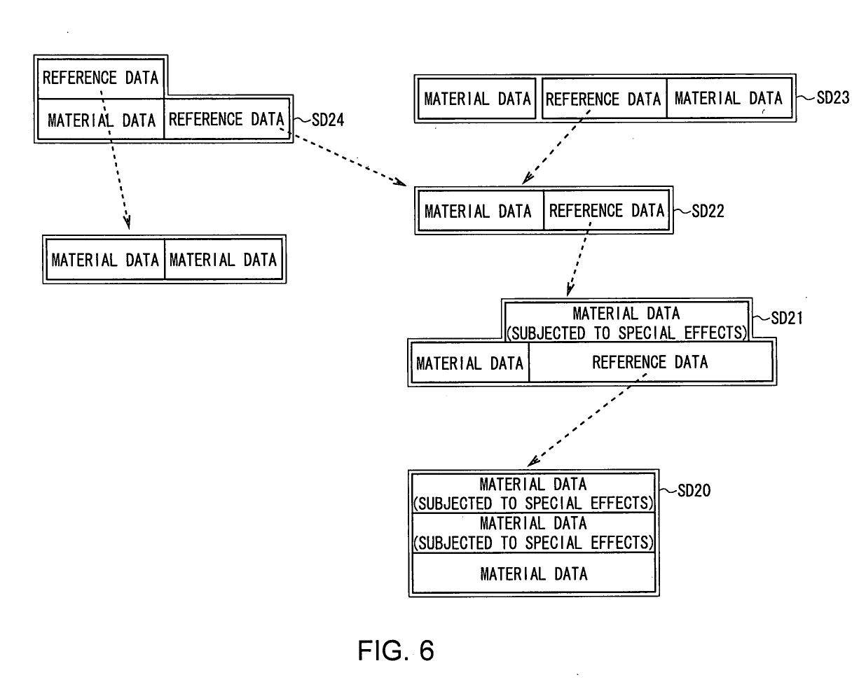

Further, the editing device 1 is capable of creating a plurality of sequence data SD21 to SD24 which hierarchically include one sequence data SD20 as shown in FIG. 6. In addition, one sequence data SD22 can be shared between two sequence data SD23 and SD24, for example, resulting in expanding the range of editing work, as compared with conventional technique.

Note that the above-described embodiment has described a case where the CPU 2 is applied as a sequence data creation means for creating sequence data by joining plural kinds of material data. This invention, however, is not limited to this and a micro processing unit (MPU) can be applied.

Further, the above-described embodiment has described a case where the hard disk drive 4 is applied to a storage means for storing sequence data. This invention, however, is not limited to this and a flexible disk or the like can be applied.

This invention can be applied to a personal computer, etc., having a sequence data editing function.

While there has been described in connection with the preferred embodiments of the invention, it will be obvious to those skilled in the art that various changed and modifications may be aimed, therefore, to cover in the appended claims all such changes and modifications as fall within the true spirit ad scope of the invention.

1. An editing device comprising:
sequence data creation means for creating sequence data by joining plural kinds of material data; and
storage means for storing said sequence data created by said sequence data creation means, wherein
said sequence creation means creates new sequence data based on existing said sequence data and another material data by joining the another material data and reference data to access the existing sequence data being stored in said storage means.

2. A sequence data creation method, comprising
a sequence data creation step of creating sequence data by joining plural kinds of material data; and
a storing step of storing said sequence data created in said sequence data creation step, in prescribed storage means wherein,
in said sequence data creation step, new sequence data based on existing said sequence data and another material data is created by joining the another material data to reference data to access the existing sequence data being stored in said storage means.

3. A sequence data creation program causing a computer to execute:
a sequence data creation step of creating sequence data by joining plural kinds of material data; and
a storing step of storing said sequence data created in said sequence data creation step, in prescribed storage means, wherein,
in said sequence data creation step, new sequence data based on existing said sequence data and another material data is created by joining the another material data to reference data to access the existing sequence data being stored in said storage means.
